(19) United States
(12) Patent Application Publication
(10) Pub. No.: US 2006/0015340 A1
(43) Pub. Date: Jan. 19, 2006

(54) Operating system and method

(75) Inventor: Chia-Chi Feng, Taipei (TW)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: CULTURE.COM TECHNOLOGY (MACAU) LTD., Macau, MO (US)

(21) Appl. No.: 10/891,961

(22) Filed: Jul. 14, 2004

(51) Int. Cl. G10L 15/04

(52) U.S. Cl. 704/254

(57) ABSTRACT

An operating system and method applicable to a computer environment are provided for a user to input a speech message via a user-friendly operating interface that transforms the speech message into an input signal and transmits the input signal to a speech recognition module of an operating system. The speech recognition module processes the input signal and displays the processing result on the user-friendly operating interface through the use of a speech database and an interface processing module of the operating system for the user to understand the operating procedure and result. By this operating method, the operating system can provide service for the user in an easy and quick way even if the user is not familiar with the operating interface of an operating system. And the user can perform data search, data input and activation of required programs by inputting speech messages.

### FIELD OF THE INVENTION

The present invention relates to operating systems and methods, and more particularly, to a speech operating system and method applicable to a computer environment, for a user to input a speech message to a user-friendly operating interface that converts the speech message to an input signal and transmits the input signal to a speech recognition module of the operating system, wherein the input signal is processed by the speech recognition module and the processing result is displayed on the user-friendly operating interface via a speech database and an interface processing module, such that the operating system and method can easily and quickly provide service for users who may not be familiar with an operating interface of an operating system, and the users can input and find data as well as activate required programs by inputting speech messages.

### BACKGROUND OF THE INVENTION

A conventional operating system such as Windows® from Microsoft Corporation, e.g. Win, XP, Win. 2000 or Win. 98, etc., Linux®, or Unix®, operates and usually displays a picture made by icons on a screen. Some of the icons would respectively display a list of items when being selected by a user via a mouse or keyboard. For example of the Windows system, if the icon “Start” is selected, a list of items including “Program”, “Document”, “Set up”, “Search”, “Help” and “Run” would be provided, such that the user can select any one of the items via the mouse or keyboard, and the selected item is opened in the form of window.

If the user is not familiar with an operating system, he or she needs to spend a lot of and choosing icons or items to find required data or activate required programs. This is not convenient for the user. Further, when the user is not able to operate the mouse or keyboard to select icons or items, it is not possible for the user to input a speech message to find data, input data, or activate the required programs. In other words, data search, data input, and program activation cannot be performed via input of speech messages to the conventional operating system.

Therefore, a problem to be solved here is to provide a novel operating system and method, which can easily and quickly provide serve for users who may not be familiar with an operating interface of an operating system, and allow the users to input speech messages to find data, input data, and activate required programs, so as to overcome the above drawbacks caused by the conventional operating system.

### SUMMARY OF THE INVENTION

In light of the prior-art drawbacks, a primary objective of the present invention is to provide an operating system and method applicable to a computer environment, whereby a user can input a speech message to a user-friendly operating interface that transforms the speech message into an input signal, and the operating system actuates a speech recognition module to process the input signal, allowing the processed signal to be displayed on the user-friendly operating interface, such that the user can understand the processing procedure and result and can easily use the user-friendly operating interface to perform required operations no matter if the user is familiar with a computer system or not.

Another objective of the present invention is to provide an operating system and method applicable to a computer environment, which can easily and quickly provide service via a user-friendly operating interface for a user who is not familiar with an operating interface of an operating system.

Still another objective of the present invention is to provide an operating system and method applicable to a computer environment, for allowing a user to input speech messages to find data, input data, and activate required programs.

A further objective of the present invention is to provide an operating system and method applicable to a computer environment, for allowing a user to input a speech message to activate required programs.

In order to achieve the above and other objectives, the present invention provides an operating system and method. The operating system includes a speech recognition module, a speech database, and an interface processing module.

In the operating method, when the operating system operates and a user inputs a speech message via a user-friendly operating interface, the user-friendly operating interface transforms the input speech message into an input signal that is a physical feature waveform signal corresponding to the inputted speech message, and the user-friendly operating interface transmits the physical feature waveform signal to the speech recognition module of the operating system. Upon receiving the physical feature waveform signal, the speech recognition module analyzes the physical feature waveform signal according to speech recognition principles in the speech database so as to obtain characteristic parameters of the physical feature waveform and divide a sound packet of the physical feature waveform signal into parts of consonant, wind, and vowel, as well as calculate fore and rear frequencies of the sound packet, such that the parts of consonant, wind, and vowel can be recognized respectively based on the speech recognition principles for identifying the consonant and vowel. It is to be noted that, “sound packet” refers to each syllabic sound spoken in speech, and a syllabic sound may include parts of consonant, vowel, and wind. The speech recognition principles allow a variation of four tones in Chinese speech to be identified according to calculation rules of the fore and rear frequencies, a frequency of the vowel part, and a profile variation of waveform amplitude. It is to be noted that “fore frequency” refers to an average frequency of the first quarter region of the sound packet, and “rear frequency” refers to an average frequency of the final quarter region of the sound packet. The speech recognition principles also provide combinations of the parts of consonant and vowel, or combinations of the parts of consonant and vowel and the variation of four tones, allowing the combinations to be compared with speech corresponding data in the speech database to obtain corresponding information. Then, the speech recognition module transmits the obtained information to the interface processing module. According to the information received from the speech recognition module, the interface processing module activates other programs to perform data search, data input and/or activation of required programs. The interface processing module cooperates with other programs to display the processing and performance results on the user-friendly operating interface, or provide the results in the form of speech via the user-friendly operating interface for the user, such that the user can correspondingly take a further action.

The speech recognition principles allow the sound packet to be divided into the parts of consonant, wind, and vowel and processed to calculate the fore and rear frequencies thereof. The parts of consonant, wind, and vowel are also respectively processed, recognized and combined according to the speech recognition principles. The combination of parts of consonant and vowel is compared with speech corresponding data in the speech database according to the speech recognition principles so as to obtain information corresponding to the speech message inputted by the user and identify information corresponding to the sound packet. The speech recognition principles are further used to analyze and process a carrier wave of the sound packet and an edge of a modulating sawtooth wave thereon to obtain a characteristic of timbre or tone quality. In addition, the speech recognition principles allow the variation of four tones in Chinese speech to be identified according to the calculation rules of fore and rear frequencies, the frequency of vowel part, and the profile variation of waveform amplitude. By the combination of parts of consonant and vowel and the identified variation of four tones, information corresponding to Chinese speech can be correctly recognized. In other words, in accordance with the speech recognition principles, not only information corresponding to speech without a variation of four tones such as speech of a Western language, e.g., English, but also information corresponding to Chinese speech with a variation of four tones can both be recognized.

Therefore, the operating system according to the present invention provides a user with an easy and quick way to operate the operating system via a user-friendly operating interface even if the user is not familiar with an operating interface of an operating system. Further, the operating system according to the present invention allows the user to input speech messages to find data, input data, and activate required programs. Moreover in the present invention, a physical feature waveform corresponding to the speech can be analyzed and recognized according to general speech corresponding data through the use of speech recognition principles so as to identify information corresponding to the speech without having to pre-establish a personal speech database. Thus, each user may input a personal speech message thereof to communicate with the operating system and perform required operations.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing a basic architecture of an operating system according to the present invention, and connections between the operating system and a user-friendly operating interface and between the operating system and other programs;

FIG. 2(a) is a schematic diagram showing a characteristic structure of a sound packet of an input signal in FIG. 1;

FIG. 2(b) is a schematic diagram showing parts of consonant, wind, and vowel of the sound packet of the input signal in FIG. 1;

FIG. 2(c) is a schematic diagram showing a waveform of plosive of the consonant part in FIG. 2(b);

FIG. 2(d) is a schematic diagram showing a waveform of affricate of the consonant part in FIG. 2(b);

FIG. 3 is a schematic diagram showing a characteristic structure of the vowel part of the sound packet in FIG. 2(b);

FIG. 4 is a schematic diagram showing characteristic parameters of the vowel part of the sound packet in FIG. 2(b);

FIG. 5 is a table showing frequencies of variations of four tones in Chinese speech;

FIG. 6 is a flowchart showing an operating method in the use of the operating system in FIG. 1;

FIG. 7 is a flowchart showing a set of detailed procedures for a step of analyzing, processing and recognizing a physical feature waveform signal in FIG. 6;

FIG. 8 is a flowchart showing another set of detailed procedures for the step of analyzing, processing and recognizing the physical feature waveform signal in FIG. 6;

FIG. 9 is a flowchart showing an operating process in the use of the operating system and method according to a preferred embodiment of the present invention;

FIG. 10 is a schematic diagram showing a picture displayed on a screen of a user-friendly operating interface;

FIG. 11 is a schematic diagram showing a picture displayed on the screen of the user-friendly operating interface after a speech message is inputted by a user;

FIG. 12 is a flowchart showing an operating process in the use of the operating system and method according to another preferred embodiment of the present invention;

FIG. 13 is a schematic diagram showing another picture displayed on the screen of the user-friendly operating interface;

FIG. 14 is a schematic diagram showing another picture displayed on the screen of the user-friendly operating interface after a speech message is inputted by the user;

FIG. 15 is a flowchart showing an operating process in the use of the operating system and method according to a further preferred embodiment of the present invention;

FIG. 16 is a schematic diagram showing a further picture displayed on the screen of the user-friendly operating interface; and

FIG. 17 is a schematic diagram showing a further picture displayed on the screen of the user-friendly operating interface after a speech message is inputted by the user.

### DETAILED DESCRIPTION OF THE PREFFERED EMBODIMENTS

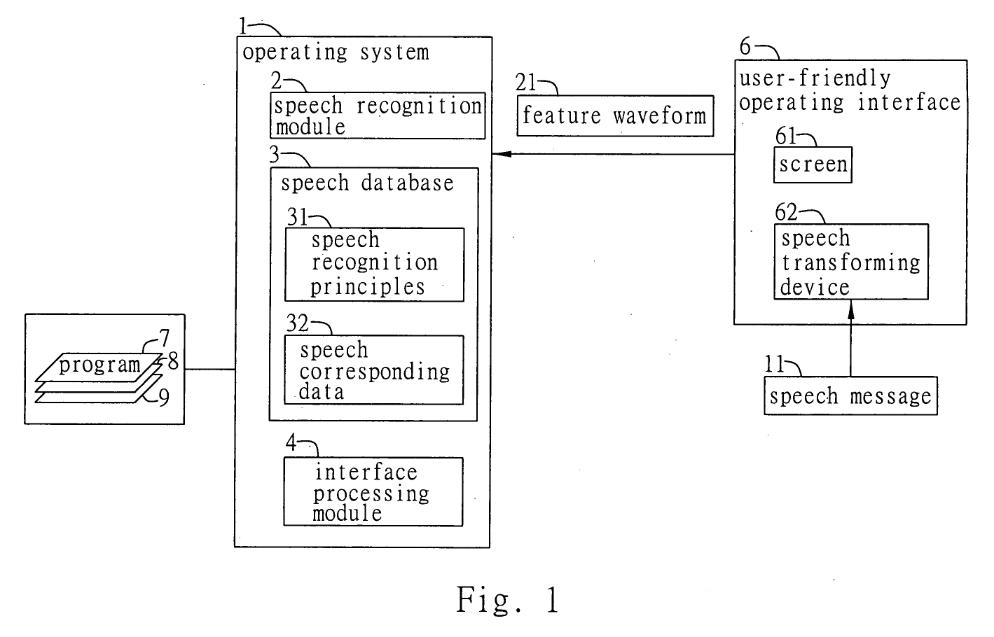

Preferred embodiments of an operating system and method proposed in the present invention are described in detail with reference to FIGS. 1 to 17.

FIG. 1 is a schematic block diagram showing basic architecture of the operating system according to the present invention, and connections between the operating system and a user-friendly operating interface and between the operating system and other programs. As shown in FIG. 1, the operating system 1 is connected to the user-friendly operating interface 6, and comprises a speech recognition module 2, a speech database 3, and an interface processing module 4. The user-friendly operating interface 6 comprises a screen 61, a speech transforming device 62, and a keyboard 63.

After a user inputs a speech message 11 to the user-friendly operating interface 6, the user-friendly operating interface 6 transforms the speech message 11 into feature waveform 21 that is a physical feature waveform signal corresponding to the speech message 11 inputted by the user, and the user-friendly operating interface 6 transmits the physical feature waveform 21 to the speech recognition module 2 of the operating system 1.

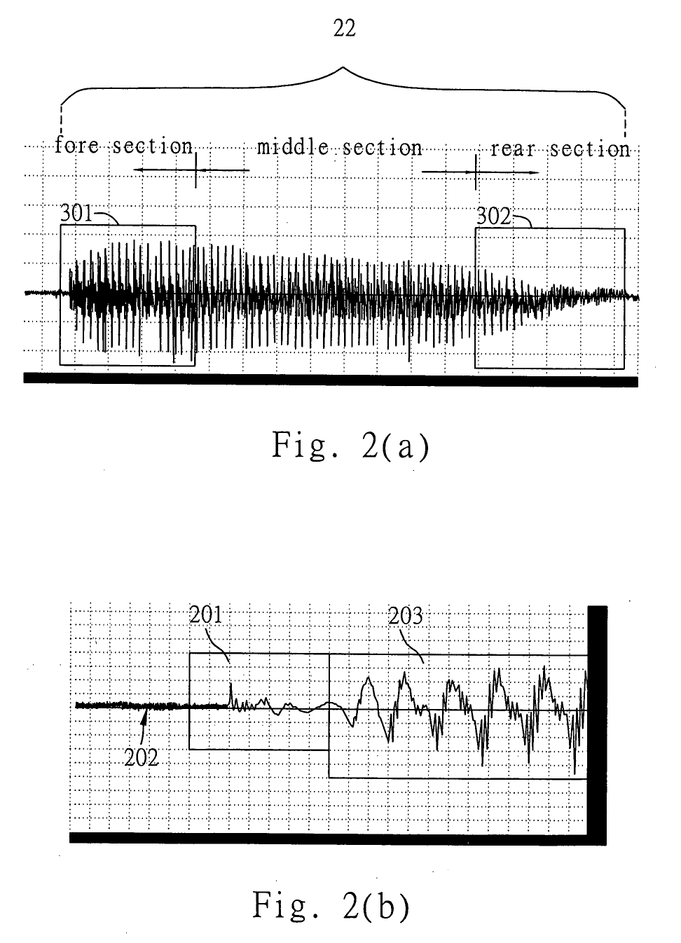

When the physical feature waveform 21 is received by the speech recognition module 2, the physical features of the feature waveform 21 corresponding to the speech message 11 are analyzed according to speech recognition principles 31 in the speech database 3, so as to obtain characteristic parameters of the physical feature waveform 21 and to divide a sound packet 22 of the physical feature waveform 21 into parts of consonant 201, wind 202 and vowel 203 (referring to FIGS. 2(a) and 2(b)). A fore frequency 301 and a rear frequency 302 of the sound packet 22 are also calculated. The parts of consonant 201, wind 202 and vowel 203 are respectively recognized according to the speech recognition principles 31 to identify the consonant and vowel. The speech recognition principles 31 also allow a variation of four tones in Chinese speech to be recognized according to calculation rules of the fore and rear frequencies 301, 302, a frequency of the vowel 203 part, and a profile variation of waveform amplitude. The speech recognition principles 31 further allow the recognized parts of consonant 201 and vowel 203, or the parts of consonant 201 and vowel 203 and the variation of four tones, to be combined and compared with speech corresponding data 32 in the speech database 3 to obtain corresponding information. The speech recognition module 2 then transmits the obtained information to the interface processing module 4.

According to the speech recognition principles 31, the sound packet 22 is divided into the parts of consonant 201, wind 202 and vowel 230 that are then recognized, processed and combined respectively, and the fore frequency 301 and rear frequency 302 of the entire sound packet 22 are calculated. When the parts of consonant 201 and vowel 230 are combined, according to the speech recognition principles 31, the combination is compared with the speech corresponding data 32 so as to obtain information corresponding to the speech message 11 inputted by the user. Further, the speech recognition principles 31 allow a carrier wave of the entire sound packet 22 and an edge of a modulated sawtooth wave thereon to be analyzed and processed to obtain a characteristic of timbre or tone quality. In addition, the variation of four tones in Chinese speech can be recognized according to the calculation rules of fore and rear frequencies 301, 302, the frequency of vowel 203 part and the profile variation of waveform amplitude. By the combination of parts of consonant 201 and vowel 203 and the recognized variation of four tones, information corresponding to Chinese speech can be correctly identified. In other words, according to the speech recognition principles 31, not only information corresponding to speech without a variation of four tones such as speech of a Western language, e.g., English, but also information corresponding to Chinese speech with a variation of four tones can both be recognized.

For an English speech without a variation of four tones, in the use of the speech recognition principles 31, the combination of parts of consonant 201 and vowel 203 is compared with the speech corresponding data 32 to thereby obtain information corresponding to the speech message 11 inputted by the user.

For Chinese speech with a variation of four tones, besides using the combination of parts of consonant 201 and vowel 203 to identify information corresponding to the sound packet 22, the variation of four tones can be recognized according to the calculation rules of fore and rear frequencies 301, 302, the frequency of vowel 203 part and the profile variation of the waveform amplitude. As a result, by the combination of parts of consonant 201 and vowel 203 and the recognized variation of four tones, information corresponding to Chinese speech can be correctly recognized.

The speech recognition principles 31 in speech database 3 are described with reference to FIGS. 2(a)-2(d), 3, 4 and 5.

The interface processing module 4 activates other programs to perform data search, data input and/or activation of required programs according to the information received from the speech recognition module 2. The interface processing module 4 cooperates with other programs 7, 8, 9 to display the processing and performance results on the user-friendly operating interface 6 or provide the results in the form of speech via the user-friendly operating interface 6 for the user to take a further action.

The speech recognition principles 31 allow the physical features of the feature waveform 21 to be analyzed and identified according to general speech corresponding data without having to pre-establish a specific personal speech database. Thus, each user may input a personal speech message thereof to communicate with the operating system 1 and perform required operations.

FIG. 2(a) is a schematic diagram showing a characteristic structure of the sound packet of the feature waveform in FIG. 1. As shown in FIG. 2(a), the physical feature waveform 21 of the sound packet 22 can be separated into a fore section, a middle section and a rear section. The parts of wind 202 and consonant 201 reside in the fore section and are followed by the vowel 203 part, and the wind 202 part is higher in frequency than the parts of consonant 201 and vowel 203. In the first quarter region of the sound packet 22, the fore frequency 301 can be obtained by randomly sampling several sub-packets and calculating an average frequency of the sampled sub-packets. The sub-packet is defined as a waveform section in the first quarter region of the sound packet 22. Similarly, in the final quarter region of the sound packet 22, the rear frequency 302 can be obtained by randomly sampling several sub-packets and calculating an average frequency of the sampled sub-packets. Further in FIG. 2(a), a carrier wave of the sound packet 22 and edges of a modulated sawtooth wave thereon as well as a variation of amplitude volume of the sound packet 22 are shown.

FIG. 2(b) is a schematic diagram showing the parts of consonant, wind, and vowel of the sound packet of the feature waveform in FIG. 1. As shown in FIG. 2(b), the sound packet 22 of the general physical feature waveform 21 can be separated into the parts of consonant 201, wind 202 and vowel 203.

In general, the consonant 201 part has waveform of one of gradation, affricate, extrusion, and plosive. Gradation is characterized in having a variation of sound volume for the consonant waveform, such as Chinese phonetic symbols “ [symbol] ”, “ [symbol] ”, “ [symbol] ” and “ [symbol] ” (pronounced as “h”, “x”, “r” and “s” respectively). Affricate is characterized in having the consonant waveform with a lingering sound followed by vowel waveform, such as Chinese phonetic symbols “ [symbol] ”, “ [symbol] ”, “ [symbol] ”, “ [symbol] ” and “ [symbol] ” (pronounced as “m”, “f”, “n”, “l ” and “j” respectively). Extrusion is sounded as plosive having slower consonant waveform, such as Chinese phonetic symbols “ [symbol] ” and “ [symbol] ” (pronounced as “zh” and “z” respectively). Plosive has its consonant waveform containing two or more immediately amplified peaks, such as Chinese phonetic symbols “ [symbol] ”, “ [symbol] ”, “ [symbol] ”, “ [symbol] ”, “ [symbol] ”, “ [symbol] ” and “ [symbol] ” (pronounced as “b”, “p”, “d”, “t”, “g”, “k”, and “q” respectively). The wind 202 part is much higher in frequency than the parts of consonant 201 and vowel 203. The vowel 203 part corresponds to a waveform section immediately following that of the consonant 201 part.

FIG. 2(c) a schematic diagram showing waveform of plosive of the consonant part in FIG. 2(b). Plosive is characterized in having waveform thereof containing two or more immediately amplified peaks, such as Chinese phonetic symbols “ [symbol] ”, “ [symbol] ”, “ [symbol] ”, “ [symbol] ”, “ [symbol] ”, “ [symbol] ” and “ [symbol] ”.

FIG. 2(d) is a schematic diagram showing waveform of affricate of the consonant part in FIG. 2(b). Affricate is characterized in having the consonant waveform with a lingering sound followed by vowel waveform, such as Chinese phonetic symbols “ [symbol] ”, “ [symbol] ”, “ [symbol] ”, “ [symbol] ” and “ [symbol] ”.

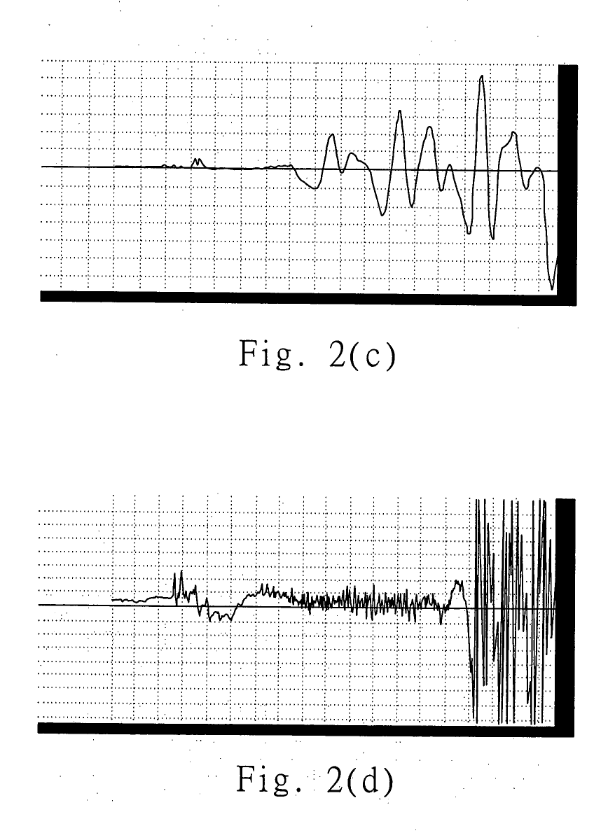

FIG. 3 is a schematic diagram showing a characteristic structure of the vowel part of the waveform in FIG. 2(b). As shown in FIG. 3, repeated waveform regions in the vowel 203 part are called vowel packets 230-233. The vowel packet 230 is an initial vowel packet formed at the beginning of the vowel 203 part, and the vowel packets 231-233 are formed by repetitions of vowel. The following vowel packets can be similarly observed and determined. In this case, the repeated waveform packets of the vowel 203 part are divided into a plurality of independent divided packets or vowel packets 230, 231, 232, 233.

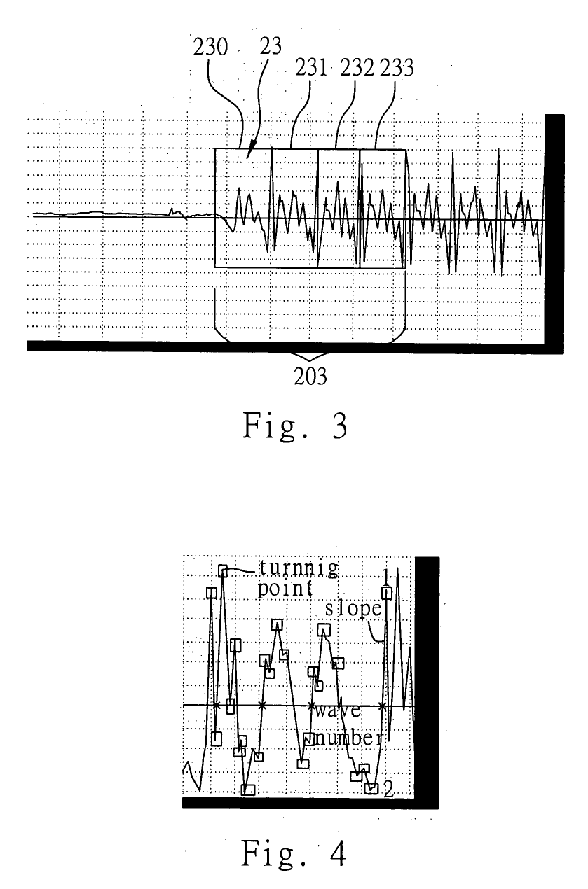

FIG. 4 is a schematic diagram showing characteristic parameters of the vowel part of the sound packet of the physical feature waveform in FIG. 2(b). As shown in FIG. 4, characteristic parameters, such as turning number, wave number, and slope, of the vowel 203 part can be obtained according to a divided vowel packet. In this case, the turning number is the number of turning points where the waveform changes the sign of slope, which are encircled by squares in the drawing. The wave number is the number of times for the waveform of the vowel packet passing through the X axis from a lower domain to an upper domain. For example in FIG. 4, the wave number is 4 counted by the points marked as x for showing the waveform passing through the X axis. The slope can be obtained by measuring a slope or sampling numbers between squares 1 and 2 in FIG. 4. The above three characteristic parameters after being obtained can be used to recognize vowels according to predetermined rules, wherein vowels of Chinese phonetic symbols include “ [symbol] ”, “ [symbol] ”, “ [symbol] ”, “ [symbol] ” and “ [symbol] ” (pronounced as “a”, “o”, “i”, “e” and “u” respectively). For example, if wave number >=slope, the vowel is “ [symbol] ”, otherwise it is “ [symbol] ”; or if wave number>=6 and turning number<10, the vowel is “ [symbol] ”; otherwise it is “ [symbol] ”. If turning number>wave number, the vowel is “ [symbol] ”; or if wave number=3 and turning number<13, the vowel is “ [symbol] ”, otherwise it is “ [symbol] ”. If turning number>wave number, the vowel is “ [symbol] ”; or if wave number=4 or 5 and turning number>three times of wave number, the vowel is “ [symbol] ”. If wave number=3 and turning number<6, the vowel is “ [symbol] ”. If wave number=2 and turning number<5, the vowel is “ [symbol] ”, otherwise it is “ [symbol] ”; or if wave number=1 and turning number<7, the vowel is “ [symbol] ”, otherwise it is “ [symbol] ”.

For recognizing a variation of four tones in Chinese speech, a fore frequency can be obtained by randomly sampling several sub-packets in the first quarter region of the sound packet and calculating an average frequency of the sampled sub-packets. Similarly, a rear frequency is obtained by randomly sampling several sub-packets in the final quarter region of the sound packet and calculating an average frequency of the sampled sub-packets.

A phrase “differ by points” refers to a difference in the number of sampling points that relates to frequency. For example, a sampling frequency of 11 KHz corresponds to taking one sampling point per 1/11000 second; that is, 11K sampling points are taken in sampling time of 1 second. Likewise, a sampling frequency of 50 KHz corresponds to taking one sampling point per 1/50000 second; that is, 50K sampling points are taken in sampling time of 1 second. In other words, the number of sampling points taken within 1-second sampling time is identical to the value of frequency.

Once the fore and rear frequencies are obtained, a variation of four tones in Chinese speech can be identified by the following rules:
1. if the fore and rear frequencies differ by 4 points, the tone is the first tone of Chinese speech;
2. if the fore and rear frequencies differ by 5 points and the fore frequency is higher than the rear frequency, the tone is either the first tone or the second tone of Chinese speech;
3. if the rear frequency is higher than the fore frequency and a difference in value between the fore and real frequencies is greater than half of the fore frequency, the tone is the fourth tone of Chinese speech; and
4. the fore and rear frequencies can be used to determine the third and fourth tones of Chinese speech; if the fore frequency of speech from a female is smaller than 38 points, the tone is determined as the fourth tone; if the fore frequency of the female speech is greater than 60 points, the tone is determined as the third tone; if the fore frequency of speech from a male is smaller than 80 points, the tone is determined as the fourth tone; if the fore frequency of the male speech is greater than 92 points, the tone is determined as the third tone.

For identifying a characteristic timbre or tone quality of speech, a carrier wave of the entire sound packet and edges of a modulated sawtooth wave thereon are analyzed and processed according to the speech recognition principles. The carrier wave of the sound packet corresponds to sawtooth edges of waveform for the speech. A frequency of the carrier wave and an amplitude variation for the sound packet of waveform corresponding to the speech differ between different persons. In other words, the timbre between speech from different persons can be differentiated according to different carrier wave frequencies and amplitude variations for the sound packets of waveform corresponding to the speech.

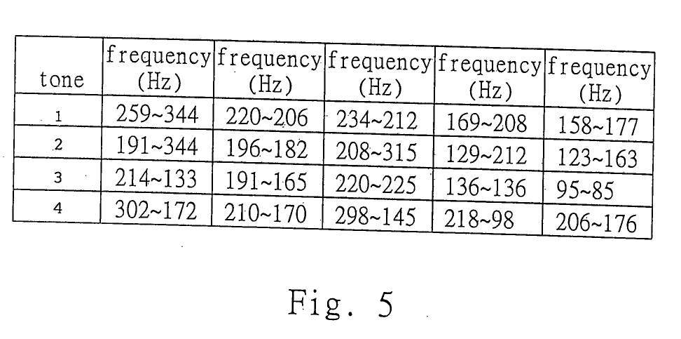

FIG. 5 is a table showing frequencies of variations of four tones in Chinese speech. As shown in FIG. 5, for example, if a frequency of speech is between 259 Hz and 344 Hz, a tone thereof is the first tone. If a frequency of speech is between 182 Hz and 196 Hz, a tone thereof is the second tone. If a frequency of speech is between 220 Hz and 225 Hz, a tone thereof is the third tone. If a frequency of speech is between 176 Hz and 206 Hz, a tone thereof is the fourth tone.

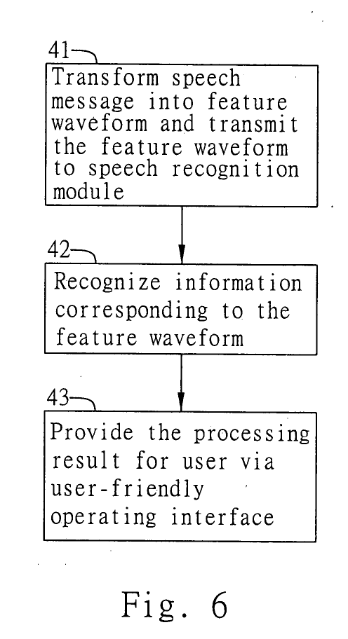

FIG. 6 is a flowchart showing an operating method in the use of the operating system in FIG. 1. As shown in FIG. 6, in step 41, a user inputs a speech message 11 to the user-friendly operating interface 6 that transforms the speech message 11 into feature waveform 21, wherein the feature waveform 21 is a physical feature waveform signal corresponding to the speech message 11 inputted by the user. The user-friendly operating interface 6 transmits the feature waveform 21 to the speech recognition module 2 of the operating system 1. Then, it proceeds to step 42.

In step 42, the speech recognition module 2 receives the feature waveform 21, and analyzes and processes physical features of the feature waveform 21 according to the speech recognition principles 31 in the speech database 3. Further, the speech recognition module 2 recognizes information corresponding to the feature waveform 21 according to the speech recognition principles 31 and speech corresponding data 32 in the speech database 3. And the speech recognition module 2 transmits the obtained information to the interface processing module 4. Then, it proceeds to step 43.

In step 43, the interface processing module 4 activates other programs 7, 8, 9 to perform data search, data input and/or activation of required programs according to the information received from speech recognition module 2. The interface processing module 4 cooperates with the programs 7, 8, 9 to display the processing and performance results on the user-friendly operating interface 6 or provide the results in the form of speech via the user-friendly operating interface 6 for the user to take a further action.

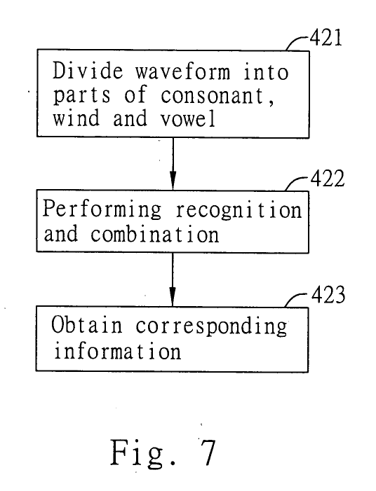

FIG. 7 is a flowchart showing a set of detailed procedures for the step of analyzing, processing and recognizing the physical feature waveform 21 in FIG. 6. As shown in FIG. 7, in step 421, the physical features of the feature waveform 21 are analyzed by the speech recognition module 2 according to the speech recognition principles 31 in the speech database 3, so as to obtain characteristic parameters of the physical feature waveform 21 and divide a sound packet 22 of the feature waveform 21 into parts of consonant 201, wind 202 and vowel 203. Then, it proceeds to step 422.

In step 422, the speech recognition module 2 recognizes, processes and combines the parts of consonant 201, wind 202 and vowel 203 of the sound packet 22 respectively according to the speech recognition principles 31 in the speech database 3. The speech recognition module 2 recognizes the parts of consonant 201, wind 202 and vowel 203 of the sound packet 22 respectively according to the speech recognition principles 31, so as to determine and analyze waveform characteristics of the parts of consonant 201, wind 202 and vowel 203 to identify the consonant 201 and vowel 203. Further according to the speech recognition principles 31, the recognized parts of consonant 201 and vowel 203 can be combined. Then, it proceeds to step 423.

In step 423, the speech recognition module 2 compares the combination of parts of consonant 201 and vowel 203 with the speech corresponding data 32 in the speech database 3, so as to obtain information corresponding to the combination. The speech recognition module 2 transmits the obtained information to the interface processing module 4. This completes the step of analyzing, processing and recognizing the physical feature waveform 21.

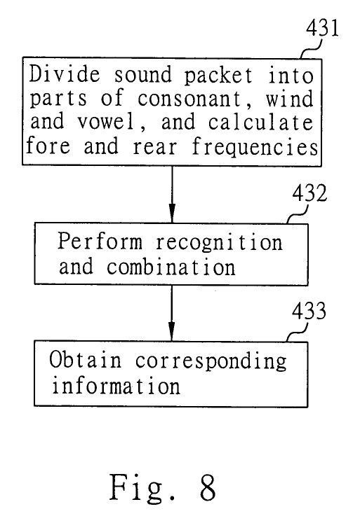

FIG. 8 is a flowchart showing another set of detailed procedures for the step of analyzing, processing and recognizing the physical feature waveform 21 in FIG. 6. As shown in FIG. 8, in step 431, the speech recognition module 2 analyzes the physical features of the feature waveform 21 according to the speech recognition principles 31 in the speech database 3, so as to obtain characteristic parameters of the physical feature waveform 21 such that a sound packet 22 of the physical feature waveform 21 can be divided into parts of consonant 201, wind 202 and vowel 203, and a fore frequency 301 and a rear frequency 302 of the sound packet 22 can be calculated. Then, it proceeds to step 432.

In step 432, the speech recognition module 2 recognizes, processes and combines the parts of consonant 201, wind 202 and vowel 203 respectively according to the speech recognition principles 31, so as to identify the consonant 201 and vowel 203. The speech recognition principles 31 also allow a variation of four tones in Chinese speech to be obtained according to calculation rules of the fore and rear frequencies 301, 302, a frequency of the vowel 203 frequency and a profile variation of the waveform amplitude. Further, the speech recognition principles 31 allow the recognized parts of consonant 201 and vowel 203, or the recognized parts of consonant 201 and vowel 203 and the variation of four tones, to be combined. Then, it proceeds to step 433.

In step 433, the speech recognition module 2 compares the combination with the speech corresponding data 32 in the speech database 3, so as to obtain information corresponding to the combination. And the speech recognition module 2 transmits the obtained information to the interface processing module 4. This completes the step of analyzing, processing and recognizing the physical feature waveform 21.

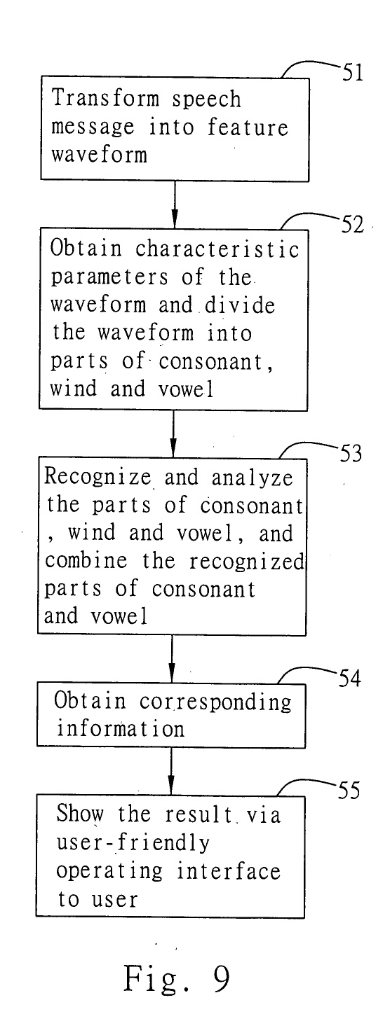

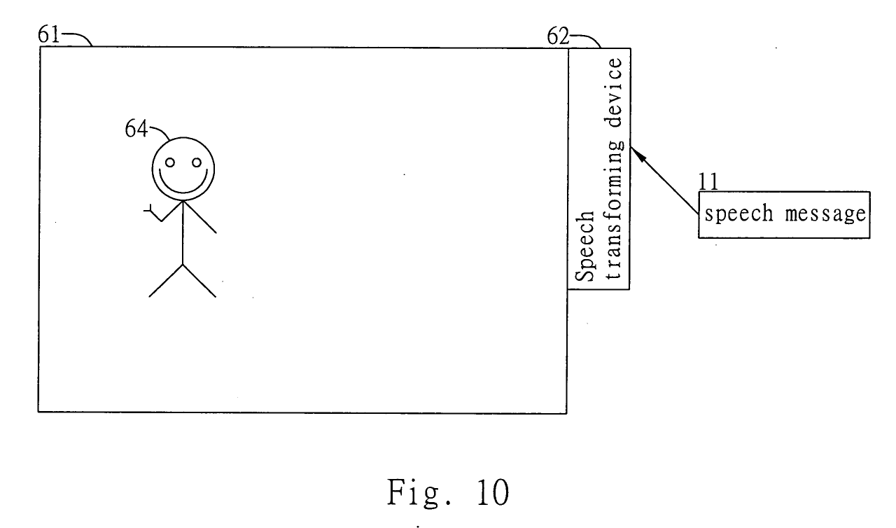

FIG. 9 is a flowchart showing an operating process in the use of the operating system and method according to a preferred embodiment of the present invention. Referring to FIG. 9, in step 51, a picture of a human image 64 as shown in FIG. 10 is displayed on the screen 61 of the user-friendly operating interface 6. A user can input a speech message 11 to the speech transforming device 62 of the user-friendly operating interface 6. For example, the user speaks English and the speech message 11 is an English speech message of “find a data file xxx.yyy”. The speech message 11 is transformed into feature waveform 21 by the user-friendly operating interface 6, wherein the feature waveform 21 is a physical feature waveform signal corresponding to the speech message 11. The physical feature waveform 21 is transmitted to the speech recognition module 2 of the operating system 1 by the user-friendly operating interface 6. Then, it proceeds to step 52.

In step 52, since the speech message 11 inputted by the user is not a single word but a sentence, the feature waveform 21 comprises a plurality of sound packets 22. The speech recognition module 2 divides the plurality of sound packets 22 corresponding to the sentence into single sound packets 22, and processes the single sound packets 22 respectively. The speech recognition module 2 analyzes physical features of a waveform signal of each of the sound packets 22, so as to obtain characteristic parameters of each of the sound packets 22 and divide each of the sound packets 22 into parts of consonant 201, wind 202 and vowel 203. Then, it proceeds to step 53.

In step 53, the speech recognition module 2 recognizes, processes and combines the parts of consonant 201, wind 202 and vowel 203 of each of the sound packets 22 respectively according to the speech recognition principles 31. The speech recognition module 2 recognizes the parts of consonant 201, wind 202 and vowel 203 respectively according to the speech recognition principles 31, so as to determine and analyze waveform characteristics of the parts of consonant 201, wind 202 and vowel 203 to identify the consonant 201 and vowel 203 for each of the sound packets 22. Further, the recognized parts of consonant 201 and vowel 203 of each of the sound packets 22 can be combined according to the speech recognition principles 31. Then, it proceeds to step 54.

In step 54, the speech recognition module 2 compares the combination of parts of consonant 201 and vowel 203 with the speech corresponding data 32 in the speech database 3, so as to obtain information corresponding to the combination. The obtained information is transmitted to the interface processing module 4 by the speech recognition module 2. Then, it proceeds to step 55.

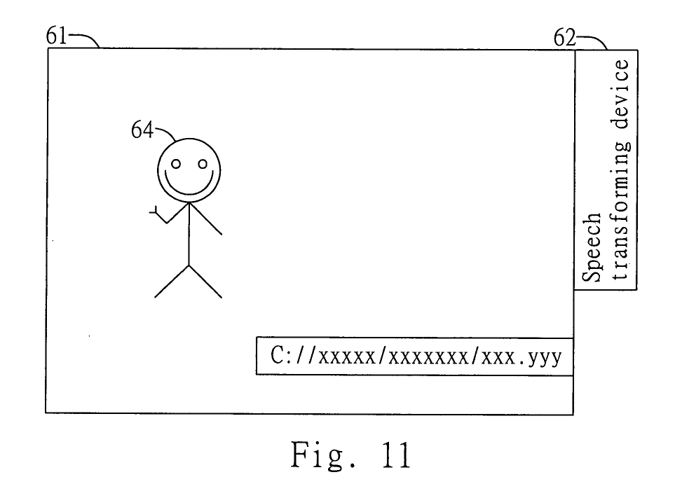

In step 55, according to the information received from the speech recognition module 2, the interface processing module 4 realizes that the user intends to find a data file xxx.yyy and thus activates other programs 7 to perform an action for the finding the data file xxx.yyy. The interface processing module 4 cooperates with the programs 7 to display the processing and performance results on the screen 61 of the user-friendly operating interface 6 as shown in FIG. 11 for the user to take a further action.

FIG. 10 is a schematic diagram showing a picture displayed on the screen of the user-friendly operating interface. As shown in FIG. 10, the picture of human image 64 is shown on the screen 61 of the user-friendly operating interface 6, such that the user can communicate with the user-friendly operating interface 6 just like talking to a real human to input the speech message 11 to the speech transforming device 62 of the user-friendly operating interface 6, and a different picture would be displayed on the screen 61 in accordance with the speech message 11 being inputted.

FIG. 11 is a schematic diagram showing a picture displayed on the screen of the user-friendly operating interface after a speech message is inputted by the user. When the user inputs the speech message 11 to the speech transforming device 62 of the user-friendly operating interface 6, wherein for example the speech message 11 is speech of “find a data file xxx.yyy”, the speech message 11 is transformed by the user-friendly operating interface 6 into feature waveform 21 that is a physical feature waveform signal corresponding to the speech message 11. The physical feature waveform 21 is transmitted by the user-friendly operating interface 6 to the operating system 1 for further processing. The operating system 1 displays the processing result on the screen 61 of the user-friendly operating interface 6. As shown in FIG. 11, the picture of human image 64 and a catalog path of the requested data file xxx.yyy are shown on the screen 61.

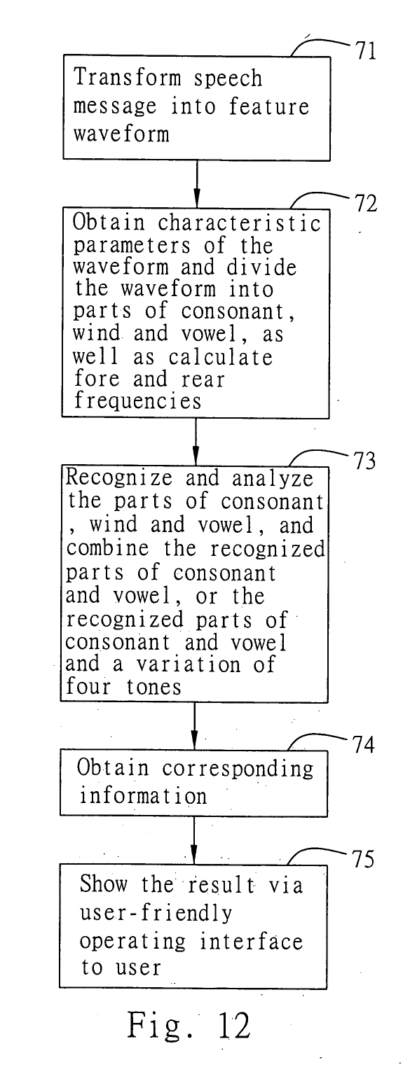

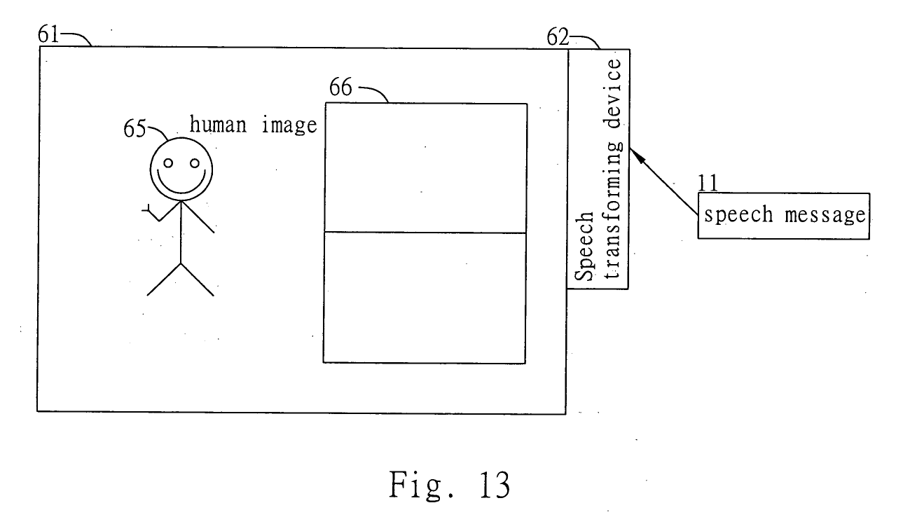

FIG. 12 is a flowchart showing an operating process in the use of the operating system and method according to another preferred embodiment of the present invention. In this embodiment, a dialog box is used for a user to request search and inquiry to obtain required answers and explanations. Referring to FIG. 12, in step 71, a picture having a human image 65 and a dialog box 66 as shown in FIG. 13 is displayed on the screen 61 of the user-friendly operating interface 6. The user can input a speech message 11 to the speech transforming device 62 of the user-friendly operating interface 6, wherein for example, the user speaks Chinese, and the input message 11 is Chinese speech of “ [symbol] [symbol] ” (which means how to perform a connection with a network). The speech message 11 is transformed by the user-friendly operating interface 6 into feature waveform 21 that is a physical feature waveform signal corresponding to the speech message 11 inputted by the user. The physical feature waveform 21 is transmitted by the user-friendly operating interface 6 to the speech recognition module 2 of the operating system 1. Then, it proceeds to step 72.

In step 72, since the speech message 11 inputted by the user is not a single word but a Chinese sentence, the feature waveform 21 comprises a plurality of sound packets 22. The speech recognition module 2 divides the plurality of sound packets 22 into single sound packets 22, and processes the single sound packets 22 respectively. According to the speech recognition principles 31 in the speech database 3, the speech recognition module 2 analyzes physical features of a waveform signal of each of the sound packets 22 so as to obtain characteristic parameters of each of the sound packets 22 such that each of the sound packets 22 is divided into parts of consonant 201, wind 202 and vowel 203, and a fore frequency 301 and a rear frequency 302 of each of the sound packets 22 are calculated. Then, it proceeds to step 73.

In step 73, the speech recognition module 2 recognizes the parts of consonant 201, wind 202 and vowel 203 respectively according to the speech recognition principles 31 so as to determine and analyze waveform characteristics of the parts of consonant 201, wind 202 and vowel 203 to identify the consonant 201 and vowel 203 for each of the sound packets 22. The speech recognition principles 31 also allow a variation of four tones in Chinese speech to be recognized according to calculation rules of the fore and rear frequencies 301, 302, a frequency of the vowel 203 part and a profile variation of waveform amplitude. The speech recognition principles 31 further allow the recognized parts of consonant 201 and vowel 203, or the recognized parts of consonant 201 and vowel 203 and the variation of four tones, to be combined. Then, it proceeds to step 74.

In step 74, the speech recognition module 2 compares the combination of parts of consonant 201 and vowel 203, the combination of the parts of consonant 201 and vowel 203 and the variation of four tones, with the speech corresponding data 32 in the speech database 3, so as to obtain information corresponding to the combinations. The obtained information is transmitted by the speech recognition module 2 to the interface processing module 4. Then, it proceeds to step 75.

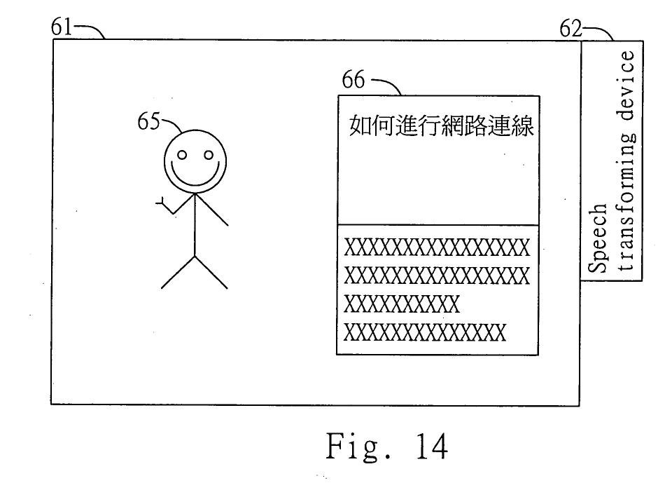

In step 75, according to the information received from the speech recognition module 2, the interface processing module 4 realizes that the user requests “ [symbol] [symbol] ” (which means how to perform a connection with a network), and thus activates other programs 8 to perform an explanation of how to perform a connection with a network. The interface processing module 4 displays the processing and performance results on the screen 61 of the user-friendly operating interface 6 as shown in FIG. 14 for the user to take a further action.

FIG. 13 is a schematic diagram showing another picture displayed on the screen of the user-friendly operating interface. As shown in FIG. 13, a picture having the human image 65 and the dialog box 66 is displayed on the screen 61 of the user-friendly operating interface 6 such that the user can communicate with the user-friendly operating interface 6 just like talking to a real human to input the speech message 11 to the speech transforming device 62 of the user-friendly operating interface 6, and another picture showing the inquiry result would be displayed on the screen 61 in accordance with the speech message 11 being inputted.

FIG. 14 is a schematic diagram showing another picture displayed on the screen of the user-friendly operating interface after a speech message is inputted by the user. When the speech message 11 is inputted by the user to the speech transforming device 62 of the user-friendly operating interface 6, wherein for example the input speech message 11 is Chinese speech of [symbol] [symbol] (which means how to perform a connection with a network), the speech message 11 is transformed by the user-friendly operating interface 6 into feature waveform 21 that is a physical feature waveform signal corresponding to the speech message 11. The physical feature waveform 21 is transmitted by the user-friendly operating interface 6 to the operating system 1 for further processing. The processing result is displayed by the operating system 1 on the screen 61 of the user-friendly operating interface 6. As shown in FIG. 14, a detailed explanation of how to perform a connection with a network would be shown in the dialog box 66 on the screen 61.

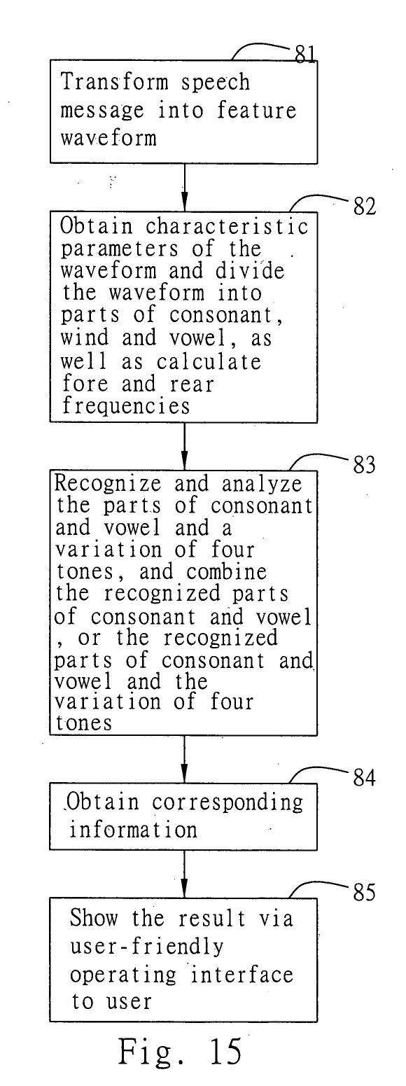

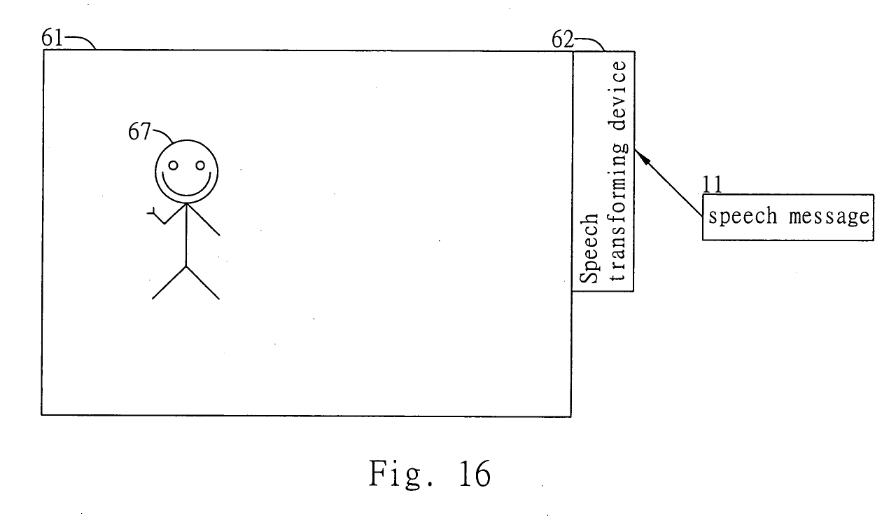

FIG. 15 is a flowchart showing an operating process in the use of the operating system and method according to a further preferred embodiment of the present invention. In this embodiment, a user intends to activate required programs and a speech message 11 may be speech containing English language and/or Chinese language, for example, speech of “ [symbol] ” (which means activating an image processing program). As shown in FIG. 15, in step 81, a picture of a human image 67 as shown in FIG. 16 is displayed on the screen 61 of the user-friendly operating interface 6. The speech message 11 is inputted by the user to the speech transforming device 62 of the user-friendly operating interface 6, and is transformed by the user-friendly operating interface 6 into feature waveform 21 that is a physical feature waveform signal corresponding to the speech message 11 inputted by the user. The physical feature waveform 21 is transmitted to the speech recognition module 2 of the operating system 1 by the user-friendly operating interface 6. Then, it proceeds to step 82.

In step 82, since the speech message 11 inputted by the user is not a single word but a sentence corresponding to speech that may contain English language and Chinese language, the feature waveform 21 comprises a plurality of sound packets 22. The speech recognition module 2 divides the plurality of sound packets 22 corresponding to the sentence into single sound packets 22, and processes the single sound packets 22 respectively. According to the speech recognition principles 31 in the speech database 3, the speech recognition module 2 analyzes physical features of a waveform signal of each of the sound packets 22 so as to obtain characteristic parameters of each of the sound packets 22, such that each of the sound packets 22 corresponding to the English part of speech is divided into parts of consonant 201, wind 202 and vowel 203. Each of the sound packets 22 corresponding to the Chinese part of speech is divided into parts of consonant 201, wind 202 and vowel 203, and its fore frequency 301 and rear frequency 302 are also calculated. Then, it proceeds to step 83.

In step 83, the speech recognition module 2 recognizes the parts of consonant 201, wind 202 and vowel 203 of each of the sound packets 22 corresponding to the English part of speech respectively according to the speech recognition principles 31 so as to determine and analyze waveform characteristics of the parts of consonant 201, wind 202 and vowel 203 to identify the consonant 201 and vowel 203 for each of the sound packets 22. For the sound packets 22 corresponding to the Chinese part of speech, besides the speech recognition module 2 using the speech recognition principles 31 to recognize the parts of consonant 201, wind 202 and vowel 203 of each of the sound packets 22 respectively so as to determine and analyze waveform characteristics of the parts of consonant 201, wind 202 and vowel 203 to identify the consonant 201 and vowel 203 for each of the sound packets 22, the speech recognition module 2 also recognizes a variation of four tones in Chinese speech according to calculation rules of the fore and rear frequencies 301, 302, a frequency of the vowel 203 part of each of the sound packets 22 and a profile variation of waveform amplitude. Moreover, the speech recognition principles 31 allow the recognized parts of consonant 201 and vowel 203, or the recognized parts of consonant 201 and vowel 203 and the variation of four tones, to be combined. Then, it proceeds to step 84.

In step 84, the speech recognition module 2 compares the combination of recognized parts of consonant 201 and vowel 203, and the combination of the recognized parts of consonant 201 and vowel 203 and the variation of four tones, with the speech corresponding data 32 in the speech database 3, so as to obtain information corresponding to the combinations. The obtained information is transmitted by the speech recognition module 2 to the interface processing module 4. Then, it proceeds to step 85.

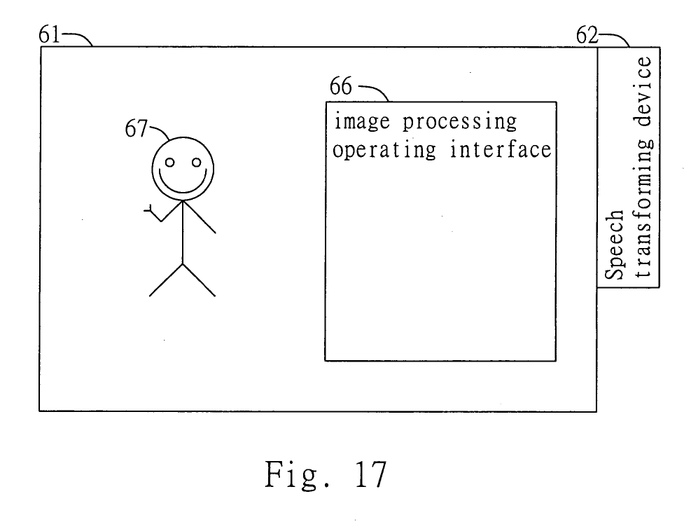

In step 85, according to the information received from the speech recognition module 2, the interface processing module 4 activates other programs 9 to perform activation of an image processing program. The interface processing module 4 cooperates with the programs 9 to display the processing and performance results on the screen 61 of the user-friendly operating interface 6 as shown in FIG. 17 for the user to take a further action.

FIG. 16 is a schematic diagram showing a further picture displayed on the screen of the user-friendly operating interface. As shown in FIG. 16, the picture of human image 67 is displayed on the screen 61 of the user-friendly operating interface 6 such that the user can communicate with the user-friendly operating interface 6 just like talking to a real human to input the speech message 11 to the speech transforming device 62 of the user-friendly operating interface 6, and another picture showing the result of activating the image processing program would be displayed on the screen 61 in accordance with the speech message 11 being inputted.

FIG. 17 is a schematic diagram showing a further picture displayed on the screen of the user-friendly operating interface after a speech message is inputted by the user. When the speech message 11 is inputted by the user to the speech transforming device 62 of the user-friendly operating interface 6, wherein for example the input speech message 11 is speech of [symbol] [symbol] (which means activating an image processing program), the speech message 11 is transformed by the user-friendly operating interface 6 into feature waveform 21 that is a physical feature waveform signal corresponding to the speech message 11. The physical feature waveform 21 is transmitted by the user-friendly operating interface 6 to the operating system 1 for further processing. The processing result is displayed by the operating system 1 on the screen 61 of the user-friendly operating interface 6. As shown in FIG. 17, an operating interface of the required image processing program being activated is shown on the screen 61.

In accordance with the above embodiments, the present invention provides an operating system and method applicable to a computer environment, for a user to input a speech message via a user-friendly operating interface that transforms the speech message into an input signal and transmits the input signal to a speech recognition module of the operating system. The speech recognition module processes the input signal and shows the processing result on the user-friendly operating interface through the use of a speech database and an interface processing module of the operating system. As a result, the operating system and method in the present invention easily and quickly provide service for the user even if the user is not familiar with an operating interface of an operating system. Moreover, the user can input speech messages to perform data search, data input and activation of required programs. The advantages of the operating system and method according to the present invention are described below.
1. The operating system, upon receiving the input signal from the user-friendly operating interface, activates the speech recognition module to process the input signal and displays the processing result on the user-friendly operating interface for the user to understand the operating procedure and result, such that the user can easily input the speech message via the user-friendly operating interface no matter whether the user is familiar with a computer system or not.
2. When the user is not familiar with an operating interface of an operating system, the operating system according to the present invention and the user-friendly operating interface can provide service for the user in an easy and quick way.
3. The user can perform data search, data input and activation of required programs by inputting speech messages.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. An operating method applicable to a computer environment, comprising the steps of:
upon receiving an input signal, analyzing and processing the input signal via an operating system to obtain information corresponding to the input signal; and
having the operating system activate programs and perform actions according to the information corresponding to the input signal.

2. The operating method of claim 1, wherein the step of analyzing and processing the input signal comprises:
dividing a sound packet of the input signal into different parts and recognizing the parts; and
combining the recognized parts to determine information corresponding to the combination.

3. The operating method of claim 2, wherein the sound packet is divided into the parts of consonant, wind and vowel.

4. The operating method of claim 3, wherein the consonant part has waveform of one of gradation, affricate, extrusion and plosive; the vowel part has repeated waveform packets; and the wind part is higher in frequency than the parts of consonant and vowel.

5. The operating method of claim 4, wherein the vowel part has characteristic parameters comprising turning number, wave number and slope.

6. The operating method of claim 4, wherein the repeated waveform packets of the vowel part are divided.

7. The operating method of claim 1, wherein the step of analyzing and processing the input signal comprises:
dividing a sound packet of the input signal into different parts and recognizing the parts, and calculating a fore frequency and a rear frequency of the sound packet, so as to recognize a variation of tones in a speech according to calculation rules of the fore and rear frequencies; and
combining the recognized parts and the variation of four tones to determine information corresponding to the combination.

8. The operating method of claim 7, wherein the sound packet is divided into the parts of consonant, wind and vowel.

9. The operating method of claim 8, wherein the consonant part has waveform of one of gradation, affricate, extrusion and plosive; the vowel part has repeated waveform packets; and the wind part is higher in frequency than the parts of consonant and vowel.

10. The operating method of claim 9, wherein the vowel part has characteristic parameters comprising turning number, wave number and slope.

11. The operating method of claim 9, wherein the repeated waveform packets of the vowel part are divided.

12. An operating method applicable to a computer environment, for a user to input a speech message via a user-friendly operating interface that transforms the speech message into an input signal and transmits the input signal to an operating system, the operating method comprising the steps of:
upon receiving the input signal, analyzing and processing via a speech recognition module of the operating system physical features of the input signal according to speech recognition principles so as to recognize information corresponding to the input signal, and transmitting the recognized information to an interface processing module of the operating system; and
upon receiving the information from the speech recognition module, activating other programs via the interface processing module to perform actions required by the user.

13. An operating method applicable to a computer environment, for a user to input a speech message via a user-friendly operating interface that transforms the speech message into an input signal and transmits the input signal to an operating system, the operating method comprising the steps of:
upon receiving the input signal, analyzing and processing via a speech recognition module of the operating system physical features of the input signal according to speech recognition principles, and recognizing information corresponding to the input signal via the speech recognition module according to the speech recognition principles and transmitting the recognized information to an interface processing module of the operating system; and
upon receiving the information from the speech recognition module, activating via the interface processing module other programs to perform actions required by the user, and providing the processing and performance results via the interface processing module for the user through the user-friendly operating interface.

14. The operating method of claim 12, wherein the step of analyzing and processing the input signal comprises:
dividing a sound packet of the input information into different parts and recognizing the parts; and
combining the recognized parts to determine information corresponding to the combination.

15. The operating method of claim 14, wherein the sound packet is divided into the parts of consonant, wind and vowel.

16. The operating method of claim 15, wherein the consonant part has waveform of one of gradation, affricate, extrusion and plosive; the vowel part has repeated waveform packets; and the wind part is higher in frequency than the parts of consonant and vowel.

17. The operating method of claim 16, wherein the vowel part has characteristic parameters comprising turning number, wave number and slope, and the repeated waveform packets of the vowel part are divided.

18. The operating method of claim 13, wherein the step of analyzing and processing the input signal comprises:
dividing a sound packet of the input information into different parts and recognizing the parts; and combining the recognized parts to determine information corresponding to the combination.

19. The operating method of claim 18, wherein the sound packet is divided into the parts of consonant, wind and vowel.

20. The operating method of claim 19, wherein the consonant part has waveform of one of gradation, affricate, extrusion and plosive; the vowel part has repeated waveform packets; and the wind part is higher in frequency than the parts of consonant and vowel.

21. The operating method of claim 20, wherein the vowel part has characteristic parameters comprising turning number, wave number and slope, and the repeated waveform packets of the vowel part are divided.

22. The operating method of claim 12, wherein the step of analyzing and processing the input signal comprises:
dividing a sound packet of the input signal into different parts and recognizing the parts, and calculating a fore frequency and a rear frequency of the sound packet, so as to recognize a variation of tones in a speech according to calculation rules of the fore and rear frequencies; and
combining the recognized parts and the variation of four tones to determine information corresponding to the combination.

23. The operating method of claim 22, wherein the sound packet is divided into the parts of consonant, wind and vowel.

24. The operating method of claim 23, wherein the consonant part has waveform of one of gradation, affricate, extrusion and plosive; the vowel part has repeated waveform packets; and the wind part is higher in frequency than the parts of consonant and vowel.

25. The operating method of claim 24, wherein the vowel part has characteristic parameters comprising turning number, wave number and slope, and the repeated waveform packets of the vowel part are divided.

26. The operating method of claim 13, wherein the step of analyzing and processing the input signal comprises:
dividing a sound packet of the input signal into different parts and recognizing the parts and calculating a fore frequency and a rear frequency of the sound packet, so as to recognize a variation of tones in a speech according to calculation rules of the fore and rear frequencies; and
combining the recognized parts and the variation of four tones to determine information corresponding to the combination.

27. The operating method of claim 26, wherein the sound packet is divided into the parts of consonant, wind and vowel.

28. The operating method of claim 27, wherein the consonant part has waveform of one of gradation, affricate, extrusion and plosive; the vowel part has repeated waveform packets; and the wind part is higher in frequency than the parts of consonant and vowel.

29. The operating method of claim 28, wherein the vowel part has characterstic parameters comprising turning number, wave number and slope, and the repeated waveform packets of the vowel part are divided.

30. An operating method applicable to a computer environment, for a user to input a speech message via a user-friendly operating interface that transforms the speech message into an input signal and transmits the input signal to an operating system, the operating method comprising the steps of:
upon receiving the input signal, processing via a speech recognition module of the operating system at least one sound packet of the input signal, wherein if the input signal has a plurality of sound packets, the speech recognition module divides the plurality of sound packets into single sound packets, such that the speech recognition module analyzes the single sound packets respectively according to speech recognition principles in a speech database of the operating system so as to obtain characteristic parameters of each of the sound packets and divide each of the sound packets into parts of consonant, wind and vowel, and the speech recognition module recognizes and processes the parts of consonant, wind and vowel respectively of each of the sound packets and combines the parts of consonant and vowel according to the speech recognition principles;
comparing via the speech recognition module the combination of parts of consonant and vowel for each of the sound packets with speech corresponding data in the speech database so as to obtain information corresponding to the combination, and transmitting the obtained information via the speech recognition module to an interface processing module of the operating system; and
upon receiving the information from the speech recognition module, activating via the interface processing module other programs to perform actions required by the user, and providing the processing and performance results via the interface processing module for the user through the user-friendly operating interface.

31. The operating method of claim 30, wherein the speech recognition module further calculates a fore frequency and a rear frequency of each of the sound packets, and recognizes a variation of four tones in a Chinese speech according to calculation rules of the fore and rear frequencies, a frequency of the vowel part and a profile variation of waveform amplitude.

32. The operating method of claim 30, wherein the speech recognition module recognizes and processes the parts of consonant, wind and vowel respectively of each of the sound packets and combines the parts of consonant and vowel according to the speech recognition principles.

33. The operating method of claim 30, wherein the speech recognition module recognizes and processes the parts of consonant, wind and vowel respectively of each of the sound packets and combines the parts of consonant and vowel and a variation of four tones in a Chinese speech according to the speech recognition principles.

34. The operating method of claim 31, wherein the speech recognition principles in the speech database are for recognizing the parts of consonant, wind and vowel, and for recognizing the variation of four tones according to the calculation rules of fore and rear frequencies, and wherein the speech corresponding data are for determining information corresponding to a combination of the parts of consonant and vowel and information corresponding to a combination of the parts of consonant and vowel and the variation of four tones.

35. An operating system applicable to a computer environment, for a user to input a speech message via a user-friendly operating interface that transforms the speech message into an input signal and transmits the input signal to the operating system, the operating system comprising:
a speech recognition module for processing at least one sound packet of the input signal upon receiving the input signal, wherein if the input signal has a plurality of sound packets, the speech recognition module divides the plurality of sound packets into single sound packets, such that the speech recognition module analyzes the single sound packets respectively according to speech recognition principles in a speech database so as to obtain characteristic parameters of each of the sound packets and divide each of the sound packets into parts of consonant, wind and vowel; wherein the speech recognition module recognizes and processes the parts of consonant, wind and vowel respectively of each of the sound packets and combines the parts of consonant and vowel according to the speech recognition principles; and wherein the speech recognition module compares the combination of parts of consonant and vowel with speech corresponding data in the speech database so as to obtain information corresponding to the combination, and the speech recognition module transmits the obtained information to an interface processing module;
the speech database comprising the speech recognition principles and the speech corresponding data, wherein the speech recognition principles are for recognizing the parts of consonant, wind and vowel, and the speech corresponding data are for being compared with the combination of parts of consonant and vowel so as to obtain the information corresponding to the combination; and
the interface processing module for activating other programs to perform actions required by the user upon receiving the information from the speech recognition module, and for providing the processing and performance results for the user via the user-friendly operating interface.

36. The operating system of claim 35, wherein upon receiving the input signal, the speech recognition module analyzes physical features of the input signal according to the speech recognition principles in the speech database so as to obtain characteristic parameters of physical feature waveform of the input signal and divide the sound packet of the input signal into the parts of consonant, wind and vowel; the speech recognition module also calculates a fore frequency and a rear frequency of the sound packet, and recognizes the parts of consonant, wind and vowel according to the speech recognition principles; the speech recognition principles further allow a variation of four tones in a Chinese speech to be recognized according to calculation rules of the fore and rear frequencies, a frequency of the vowel part and a profile variation of waveform amplitude; and the speech recognition module combines the recognized parts of consonant and vowel and the variation of four tones, and compares the combination with the speech corresponding data in the speech database so as to obtain information corresponding to the combination, such that the speech recognition module transmits the obtained information to the interface processing module.

37. The operating system of claim 36, wherein the speech recognition principles in the speech database are for dividing the sound packet into the parts of consonant, wind and vowel, processing the sound packet to obtain the fore and rear frequencies thereof, and recognizing and processing the parts of consonant, wind and vowel respectively; when the recognized parts of consonant and vowel are combined, the speech recognition principles are for comparing the combination with the speech corresponding data so as to determine information corresponding to the speech message inputted by the user and identify information corresponding to the sound packet; the speech recognition principles are further for recognizing the variation of four tones in the Chinese speech according to the calculation rules of fore and rear frequencies, the frequency of vowel part and the profile variation of waveform amplitude; and the speech recognition principles are for comparing the combination of the parts of consonant and vowel and the variation of four tones with the speech corresponding data so as to identify information corresponding to the Chinese speech.
